(19) United States
(12) Patent Application Publication
(10) Pub. No.: US 2022/0284852 A1
(43) Pub. Date: Sep. 8, 2022

(54) ELECTROLUMINESCENT DISPLAY PANEL AND DRIVING METHOD THEREOF AND DISPLAY APPARATUS

(71) Applicants: Chengdu BOE Optoelectronics Technology Co., Ltd., Chengdu, Sichuan (CN); BOE TECHNOLOGY GROUP CO., LTD., Beijing (CN)

(72) Inventors: Miao WANG, Beijing (CN); Yonglin GUO, Beijing (CN); Kai ZHANG, Beijing (CN); Yunsheng XIAO, Beijing (CN); Xinyu WEI, Beijing (CN)

(21) Appl. No.: 17/630,236

(22) PCT Filed: Jan. 6, 2021
(86) PCT No.: PCT/CN2021/070448

§ 371 Date: Jan. 26, 2022

(30) Foreign Application Priority Data
Jan. 6, 2020 (CN) 202010008769.3

(51) Int. Cl. G09G 3/3208

(52) U.S. Cl. CPC G09G 3/3208; G09G 2300/0852; G09G 2320/0233; G09G 2300/0819; G09G 2310/0286

(57) ABSTRACT

The present disclosure provides an electroluminescent display panel and a display apparatus. The electroluminescent display panel includes at least one regular-shaped display region and at least one irregular-shaped display region, and the display panel further includes at least one first load compensation circuit in the at least one irregular-shaped display region. The at least one first load compensation circuit is electrically coupled to one of the at least one gate line, and the at least one first load compensation circuit is electrically coupled to a same gate line to which the at least one pixel unit is electrically coupled, at a side close to the at least one gate line signal input terminal with respect to the at least one pixel unit.

### CROSS-REFERENCE TO RELATED APPLICATIONS

The present application claims the priority of the Chinese Patent Application No. 202010008769.3 filed at the Chinese Intellectual Property Office on Jan. 6, 2020, the content of which is incorporated herein by reference in its entirety.

### TECHNICAL FIELD

The present disclosure relates to the field of display technology, and in particularly, relates to an electroluminescent display panel and a driving method thereof, and a display apparatus.

### BACKGROUND

In recent years, the development of smart organic light emitting diode (OLED) (or organic electroluminescent diode) mobile phones has brought about a great change to people's lives, and the market demand for the smart OLED mobile phones is increasing. A screen of the conventional OLED mobile phone cannot meet the people's visual requirements, so that a full screen is produced. The full screen enhances a screen-to-body ratio, reduces an edge space and brings great vision enjoyment for people. However, in the full screen, due to the reduction of the edge space, external devices, such as a camera, a headphone and the like, cannot be placed at the edge of the screen, so that an irregular-shaped screen, such as a bang screen, is produced, which solves the problem regarding placing the external devices but results in abnormal display in an irregular-shaped region. Since there are a different number of pixel units in the irregular-shaped display region and in the regular-shaped display region, load of a gate line in the irregular-shaped display region and load of a gate line in the regular-shaped display region are different from each other, which results in non-uniform display brightness in the irregular-shaped display region and in the regular-shaped display region of the screen.

### SUMMARY

According to one aspect, an electroluminescent display panel is provided, including at least one regular-shaped display region and at least one irregular-shaped display region, wherein the display panel further includes: at least one gate line and at least one pixel unit in each of the at least one regular-shaped display region and the at least one irregular-shaped display region; and at least one gate line signal input terminal electrically coupled to the at least one gate line, respectively, wherein the display panel further includes at least one first load compensation circuit in each of the at least one irregular-shaped display region, the at least one first load compensation circuit is electrically coupled to one of the at least one gate line, and each of the at least one first load compensation circuit, with respect to a pixel unit of the at least one pixel unit electrically coupled to a same gate line as the first load compensation circuit, is located at a side closer to a corresponding gate line signal input terminal of this gate line.

In some embodiments, the electroluminescent display panel further includes at least one second load compensation circuit and at least one gate line signal output terminal electrically coupled to the at least one gate line in each of the at least one irregular-shaped display region, wherein the at least one second load compensation circuit is electrically coupled to one of the at least one gate line, and each of the at least one second load compensation circuit, with respect to a pixel unit of the at least one pixel unit electrically coupled to a same gate line as the second load compensation circuit, is located at a side closer to a corresponding gate line signal output terminal of this gate line.

In some embodiments, each of the at least one first load compensation circuit includes at least one first capacitor, and each of the at least one second load compensation circuit includes at least one second capacitor.

In some embodiments, the at least one first capacitor includes a plurality of first capacitors coupled in parallel, and with respect to the pixel unit of the at least one pixel unit electrically coupled to a same gate line as the plurality of first capacitors, the plurality of first capacitors are located at a side of the pixel unit closer to a corresponding gate line signal input terminal of this gate line.

In some embodiments, the at least one second capacitor includes a plurality of second capacitors coupled in parallel, and with respect to the pixel unit of the at least one pixel unit electrically coupled to a same gate line as the plurality of second capacitors, the plurality of second capacitors are located at a side of the pixel unit closer to a corresponding gate line signal output terminal of this gate line.

In some embodiments, the electroluminescent display panel further includes a voltage stabilizing signal terminal, wherein each of the plurality of first capacitors includes a first electrode plate and a second electrode plate, the first electrode plate is electrically coupled to the gate line, and the second electrode plate is electrically coupled to the voltage stabilizing signal terminal.

In some embodiments, each of the plurality of second capacitors includes a third electrode plate and a fourth electrode plate, the third electrode plate is electrically coupled to the gate line, and the fourth electrode plate is electrically coupled to the voltage stabilizing signal terminal.

In some embodiments, the first electrode plate is in the same layer and made of the same material the gate line.

In some embodiments, the third electrode plate is in the same layer and made of the same material as the at least one gate line.

In some embodiments, the electroluminescent display panel further includes a voltage stabilizing signal terminal, wherein each of the plurality of first capacitors includes a first electrode plate and a second electrode plate, the gate line is also used as the first electrode plate of the first capacitor, and the second electrode plate is electrically coupled to the voltage stabilizing signal terminal.

In some embodiments, each of the plurality of second capacitors includes a third electrode plate and a fourth electrode plate, the gate line is also used as the third electrode plate of the second capacitor, and the fourth electrode plate is electrically coupled to the voltage stabilizing signal terminal.

In some embodiments, each of the at least one pixel unit includes at least one transistor on a base substrate, and each of the at least one transistor includes a gate electrode, an active layer, a source electrode, and a drain electrode, and the second electrode plate and the fourth electrode plate are in the same layer and made of the same material as the source electrode and the drain electrode of the at least one transistor.

In some embodiments, each of the at least one pixel unit includes at least one transistor on a base substrate, and each of the at least one transistor includes a gate electrode, an active layer, a source electrode, and a drain electrode, and the electroluminescent display panel further includes: a planarization layer on a side of the at least one transistor distal to the base substrate; and a light emitting element including a first electrode, an organic light emitting layer, and a second electrode sequentially arranged on the planarization layer in a direction away from the base substrate, and the second electrode plate and the fourth electrode plate are in the same layer and made of the same material as the active layer of the transistor, and the first electrode and the second electrode of the light emitting element.

In some embodiments, the at least one pixel unit in each of the at least one irregular-shaped display region and the at least one regular-shaped display region are arranged in a plurality of rows, the number of pixel units in each of the plurality of rows of pixel units in each of the at least one regular-shaped display region is greater than or equal to the number of pixel units in each of the plurality of rows of pixel units in each of the at least one irregular-shaped display region, the first load compensation circuit and the pixel unit electrically coupled to a same gate line are in a same row, and the second load compensation circuit and the pixel unit electrically coupled to a same gate line are in a same row.

In some embodiments, each of the at least one gate line includes a first end and a second end opposite to each other, and the first end is electrically coupled to a corresponding gate line signal input terminal of the gate line, and the second end is electrically coupled to a corresponding gate line signal output terminal of the gate line.

In some embodiments, each of the at least one gate line includes a first end and a second end opposite to each other, and the first end and the second end are electrically coupled to two corresponding gate line signal input terminals of the gate line, respectively, and a corresponding gate line signal output terminal of the gate line is electrically coupled to a portion of the gate line other than the first end and the second end.

In some embodiments, a capacitance value of the first capacitor is equal to a capacitance value of the second capacitor.

In some embodiments, the capacitance value of the first and second capacitors is equal to an equivalent capacitance value of the at least one pixel unit.

In some embodiments, a total number of capacitors in the at least one first load compensation circuit and/or the at least one second compensation circuit is calculated by: N=(C1−C2)/C,

where N denotes the total number of the capacitors, C1 denotes an equivalent capacitance value of one row of pixel units in the regular-shaped display region, C2 denotes an equivalent capacitance value of one row of pixel units in the irregular-shaped display region, and C denotes a capacitance value of one of the capacitors.

According to another aspect, a display apparatus is provided to include the above electroluminescent display panel and a driving circuit for driving the electroluminescent display panel.

### BRIEF DESCRIPTION OF THE DRAWINGS

FIG. 1 is a top view illustrating a partial structure of an electroluminescent display panel according to an embodiment of the present disclosure;

FIG. 2 is a cross-sectional view illustrating a partial structure of an electroluminescent display panel along a line C-C′ in FIG. 1;

FIG. 3 is a graph illustrating simulated signal waveforms of a gate line of a display panel at positions A and B in FIG. 1 in a related solution for compensation on a load of a gate line in an irregular-shaped display region;

FIG. 4 is a graph illustrating simulated signal waveforms of a gate line of a display panel at positions A and B in FIG. 1 in a solution according to an embodiment of the present disclosure for compensation on a load of a gate line in an irregular-shaped display region;

FIG. 5 is a schematic top view illustrating an irregular-shaped display region of an electroluminescent display panel according to an embodiment of the present disclosure;

FIG. 6 is an enlarged view of a partial region of an irregular-shaped display region of an electroluminescent display panel according to an embodiment of the present disclosure;

FIG. 7 is a top view illustrating a partial structure of an electroluminescent display panel according to an embodiment of the present disclosure;

FIG. 8 is a top view illustrating a partial structure in an irregular-shaped display region of an electroluminescent display panel in which signals are input to two ends of a gate line according to an embodiment of the present disclosure;

FIG. 9 is a top view illustrating a partial structure of an electroluminescent display panel according to an embodiment of the present disclosure;

FIG. 10 is a cross-sectional view illustrating a partial structure of an electroluminescent display panel along a line D-D′ in FIG. 9;

FIG. 11 is a graph illustrating simulated signal waveforms of a gate line of a display panel at positions A and B in FIG. 9 in a solution according to an embodiment of the present disclosure for compensation on a load of a gate line in an irregular-shaped display region; and

FIG. 12 is a top view illustrating a partial structure of an electroluminescent display panel according to an embodiment of the present disclosure.

### DETAILED DESCRIPTION

In order to make one of ordinary skill in the art to better understand the technical solutions of the present disclosure, an electroluminescent display panel and a driving method thereof, and a display apparatus of the present disclosure will be described in detail below with reference to the accompanying drawings and specific embodiments.

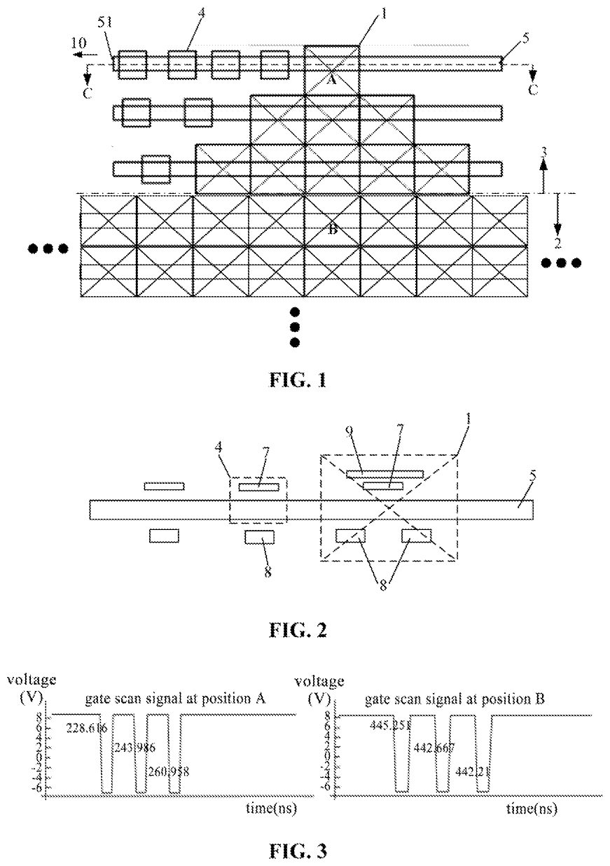

According to one aspect of the present disclosure, an electroluminescent display panel is provided. FIG. 1 is a top view illustrating a partial structure of an electroluminescent display panel with one irregular-shaped display region according to an embodiment of the present disclosure. FIG. 2 is a cross-sectional view illustrating a partial structure of an electroluminescent display panel along a line C-C′ in FIG. 1. As shown in FIGS. 1 and 2, the electroluminescent display panel may include at least one regular-shaped display region 2 and at least one irregular-shaped display region 3. The electroluminescent display panel further includes at least one gate line 5 and at least one pixel unit 1 in each of the at least one regular-shaped display region 2 and the at least one irregular-shaped display region 3, and at least one gate line signal input terminal electrically coupled (directly or indirectly) to the at least one gate line 5 respectively. A direction indicated by an arrow 10 shows where the gate line signal input terminal is located. The number of pixel units 1 in the at least one regular-shaped display region 2 is larger than the number of pixel units 1 in the at least one irregular-shaped display region 3 (i.e., a distribution density of pixel units 1 in the at least one regular-shaped display region 2 is larger than a distribution density of pixel units 1 in the at least one irregular-shaped display region 3). The electroluminescent display panel further includes at least one first load compensation circuit 4 in each of the at least one irregular-shaped display region 3. The first load compensation circuit 4 is electrically coupled to one of the at least one gate line 5, and is electrically coupled to the same gate line to which the at least one pixel unit is electrically coupled, at a side close to the gate line signal input terminal 10 with respect to the at least one pixel unit.

The irregular-shaped display region 3 is an region of the display panel where externally configured devices, such as a camera and a headphone, are integrated in the display panel. Since the externally configured devices occupy a portion of a display region of the display panel and a distribution of the pixel units 1 in the portion is irregular with respect to a distribution of the pixel units 1 in the regular-shaped display region 2, the portion is referred to as an irregular-shaped display region 3. As shown in FIG. 1, in the regular-shaped display region 2, the pixel units 1 are arranged in a regular matrix, and the number of the pixel units 1 in each of rows is constant, that is, the number of the pixel units 1, which each of gate lines 5 is electrically coupled to, is constant. In the irregular-shaped display region 3, the pixel units 1 are irregularly arranged, and the numbers of the pixel units 1 in rows are not all the same, that is, the numbers of the pixel units 1, which gate lines 5 are electrically coupled to, are not all the same. Generally, the number of the pixel units 1 electrically coupled to any gate line 5 in the irregular-shaped display region 3 is smaller than the number of the pixel units 1 electrically coupled to any gate line 5 in the regular-shaped display region 2, so that a load of each of the gate lines 5 in the irregular-shaped display region 3 is usually smaller than a load of any one of the gate lines 5 in the regular-shaped display region 2, which may result in non-uniform light emission brightness of the pixel units 1 in the irregular-shaped display region 3 and in the regular-shaped display region 2, and thus affect the display quality.

Since the load of the gate lines in the irregular-shaped display region is different from the load of the gate lines in the regular-shaped display region, the light emission brightness of a pixel unit (such as the pixel unit at the position A in FIG. 1) coupled to any gate line in the irregular-shaped display region is different from the light emission brightness of a pixel unit (which is in a same column as the pixel unit in the irregular-shaped display region, such as the pixel unit at the position B in FIG. 1) coupled to any gate line in the regular-shaped display region. Regarding the above difference in light emission brightness in the irregular-shaped display region and in the regular-shaped display region, in the related solution, a compensation capacitor (or compensation capacitors) is (or are) provided in the irregular-shaped display region, and the compensation capacitor (or compensation capacitors each) is (are) provided close to gate line signal output terminal. That is, the compensation capacitors are closer to the gate line signal output terminal than the pixel units, such that signals transmitted through the gate lines firstly pass through the pixel units and then the compensation capacitors). Although the load difference between the gate lines in value may be compensated by adopting the related solution, when signals are transmitted to the positions A and B on the two gate lines, respectively, there is still the load difference between the signals. FIG. 3 is a graph illustrating simulated signal waveforms of a gate line of a display panel at positions A and B in FIG. 1 in a related solution for compensation on a load of a gate line in an irregular-shaped display region. As shown in FIG. 3, a waveform difference between the signals on the gate lines monitored at the positions A and B is large. Specifically, there is a large difference between corresponding durations when the signals on the gate lines at the positions A and B change from a high level to a low level, respectively.

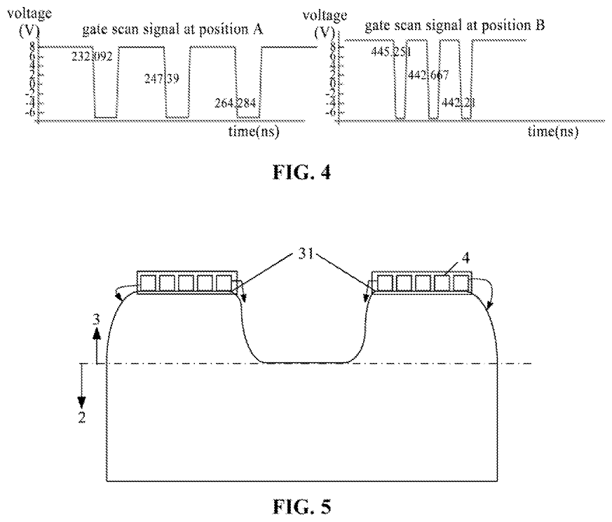

The principle of the load compensation on the gate lines 5 in the irregular-shaped display region 3 is as follows: at least one first load compensation circuit 4 is provided close to the gate line signal input terminal 10 with respect to the pixel unit 1 in the irregular-shaped display region 3 (i.e., at least one first load compensation circuit 4 is provided between the pixel unit 1 and the gate line signal input terminal 10 in the irregular-shaped display region 3), so that the load to which the signal on the gate line 5 is subject when reaching the position A is close to the load to which the signal on the gate line 5 is subject when reaching the position B. FIG. 4 is a graph illustrating simulated signal waveforms of a gate line of a display panel at positions A and B in FIG. 1 in a solution according to an embodiment of the present disclosure for load compensation on a gate line in an irregular-shaped display region. Compared to the related load compensation solution that the compensation capacitors each are provided close to the gate line signal output terminal 20, first load compensation circuits 4 in the embodiment may perform the load compensation on the gate lines 5 in the irregular-shaped display region 3 in advance, so that the signal waveforms on the gate lines at the positions A and B are similar to each other, as shown in FIG. 4. Compared to the related load compensation solution for the gate line, by adopting the load compensation solution for the gate line in the present disclosure, the difference between light emission brightness of the pixel units 1 at the positions A and B is reduced. As shown in the following table 1, for simulated signal waveform parameters of the pixel unit at the position A in the irregular-shaped display region 3, a comparison between the related load compensation solution for the gate line and the load compensation solution for the gate line in the present disclosure (Tf represents a duration for a signal changing from a high level to a low level), is shown.

TABLE 1

| | | Solution | Solution |
|---|---|---|---|
| | | in the | in the |
| | Tf(ns) | related art | invention |
| Irregular-shaped | Tf1 | 228.616 | 232.092 |
| display region | Tf2 | 243.986 | 247.39 |
| (position A) | Tf3 | 260.958 | 264.284 |
| | Average | 244.52 | 247.922 |
| | Tf | | |
| Regular-shaped | Tf1 | 445.251 | 445.251 |
| display region | Tf2 | 442.667 | 442.667 |
| (position B) | Tf3 | 442.21 | 442.21 |
| | Average | 443.376 | 443.376 |
| | Tf | | |
| Δtf (%) | | 44.85% | 44.08% |

In the above table 1, Tf1, Tf2, and Tf3 in the irregular-shaped display region refer to signals on the gate line obtained by signal acquisition of three times at the position A in the irregular-shaped display region, respectively; the average Tf at the position A in the irregular-shaped display region refers to the average value of the three signals on the gate line obtained by signal acquisition of the three times at the position A; Tf1, Tf2, and Tf3 in the regular-shaped display region refer to signals on the gate line obtained by signal acquisition of three times at the position B in the regular-shaped display region, respectively; the average Tf at the position B in the regular-shaped display region refers to the average value of the three signals on the gate line obtained by signal acquisition of the three times at the position B; Δtf=(average Tf at the position B−average Tf at the position A)/average Tf at the position B. The final purpose of compensating on the load of the gate lines in the irregular-shaped display region is to enable the signal waveforms on the gate lines, for example, at the two positions A and B, to be more consistent with each other. That is, advantageously, a difference between the parameters tf of the signals on the gate lines at the positions A and B becomes smaller. As may be seen from table 1, by adopting the load compensation solution for the gate line in the irregular-shaped display region in the embodiment, the signal waveform on the gate line at the position A in the irregular-shaped display region has a less change with respect to the signal waveform on the gate line at the position B in the regular-shaped display region, so that a better effect for the load compensation on the gate lines in the irregular-shaped display region is achieved.

In the electroluminescent display panel of the present disclosure, by providing the irregular-shaped display region 3, the problem regarding arranging externally configured devices of the display panel is solved under the condition of a small edge space of the display panel. Moreover, by providing the at least one first load compensation circuit 4 close to the gate line signal input terminal 10 relative to the pixel units 1 in the irregular-shaped display region 3, compared with the related load compensation solution in which the compensation capacitors each are provided close to the gate line signal output terminal 10, the first load compensation circuits 4 of the present disclosure may perform load compensation on the gate lines 5 in the irregular-shaped display region 3 in advance, so that the load of the gate lines 5 in the irregular-shaped display region 3 and the load of the gate lines 5 in the regular-shaped display region 2 tend to be more consistent with each other, and further the light emission brightness of the pixel units 1 in the irregular-shaped display region 3 and in the regular-shaped display region 2 tends to be uniform, thereby improving the uniformity of the display brightness of the display panel and enhancing the display quality of the display panel.

In the embodiment, the first load compensation circuit 4 may include a first capacitor, that is, the first load compensation circuit 4 may be a capacitor. A capacitance value of the capacitor of each of the at least one first load compensation circuit 4 is constant. The capacitors are adopted to provide load compensation on the gate lines 5 in the irregular-shaped display region 3, because on one hand, a manufacturing process of a capacitor is simple, and on the other hand, the capacitance value of the capacitor is easily adjusted in the manufacturing process, the load compensation on the gate lines 5 is more accurate. In the embodiment, the first load compensation circuit 4 including one capacitor is taken as an example for description, but the present disclosure is not limited thereto. The first load compensation circuit 4 may include a plurality of first capacitors.

In the irregular-shaped display region 3, the number of the first load compensation circuits 4 (i.e., the first capacitors) electrically coupled to each of the gate lines 5 is determined according to the load of each of the gate lines 5 in the irregular-shaped display region 3 and in the regular-shaped display region 2 and the capacitance value of each of the first capacitors. For example, firstly, the load of each of the gate lines 5 in the regular-shaped display region 2 may be calculated, and the load of each of the gate lines 5 in the irregular-shaped display region 3 without the load compensation is calculated. Then, the load difference between the gate lines 5 in the irregular-shaped display region 3 and in the gate lines 5 in the regular-shaped display region 2 is calculated. The number of capacitors is calculated according to the load difference and the capacitance value of the capacitor. Finally, the load of each of the gate lines 5 in the irregular-shaped display region 3 is substantially the same as the load of each of the gate lines 5 in the regular-shaped display region 2.

An example, in which the number of capacitors of the first load compensation circuit 4 electrically coupled to each of the gate lines 5 in the irregular-shaped display region 3 is determined according to the load of each of the gate lines 5 and the capacitance value of the capacitor, is as follows. Assuming that one pixel unit 1 itself has a load (i.e., has an equivalent capacitance) of 25, and one first load compensation circuit 4 itself has a load (i.e., has a capacitance) of 20. In FIG. 1, for example, if the pixel unit 1 at the position A is the 100th pixel unit along an extending direction of the gate line 5 (for example, starting from the gate line signal input terminal), and the pixel unit 1 at the position B is the 150th pixel unit along the extending direction of the gate line 5, the load of the signal on the gate line at the position A needs to be compensated by the first load compensation circuit 4. In this case, 50 pixel units 1 are missing on the left side of the position A on the gate line 5, and the number of the first load compensation circuits 4 on the left side of the position A may be calculated as (50×25)/20=62.5.

Optionally, in the embodiment, the first capacitor may include a first electrode plate and a second electrode plate, and the second electrode plate may be electrically coupled to an voltage stabilizing signal terminal (for example, for providing a driving voltage for an OLED in the pixel unit). A portion of the gate line 5 may be also used as the first electrode plate of the first capacitor.

Optionally, the pixel unit 1 may include at least one transistor on a base substrate. Each of the at least one transistor includes a gate electrode, an active layer, a source electrode, and a drain electrode. The second electrode plate of the first capacitor and the source and drain electrodes of the at least one transistor are in a same layer and made of a same material. In this case, a distance between the first electrode plate and the second electrode plate of the first capacitor and a material of the two electrode plates have the largest influence of the load compensation on the gate lines. In addition, an additional process is not added to manufacture the capacitor of the display panel, and the process for manufacturing the display panel is simple.

Optionally, the electroluminescent display panel of the present disclosure further includes: a planarization layer (not shown) on a side of the at least one transistor distal to the base substrate; and a light emitting element including a first electrode, an organic light emitting layer, and a second electrode sequentially provided on the planarization layer in a direction away from the base substrate. The second electrode plate may be in the same layer and made of the same material as any one of the active layer of the at least one transistor, and the first and second electrodes of the light emitting element. That is, the second electrode plate of the first capacitor may be in the same layer and made of the same material as any one of the active layer of the transistor, the first electrode (anode) of the light emitting element, and the second electrode (cathode) of the light emitting element. However, when the second electrode plate is made of the materials of the film layers and is in the same layer as the film layers, it has less influence of the load compensation on the gate lines compared to the case where the second electrode plate is in the same layer and made of the same material as the source and drain electrodes of the transistor. However, in order to accurately adjust the load of the gate line 5 by the capacitor, more accurate load compensation on the gate line may be performed by forming the second electrode plates of different first capacitors which are in the same layer as different film layers respectively and are made of the same material as the different film layers respectively. The materials for manufacturing the gate line, the active layer, the source and drain electrodes, and the first and second electrodes of the light emitting element may be materials required for manufacturing corresponding structures in the related art.

It should be noted that, as shown in FIG. 2, the load of the gate line 5 mainly refers to a load produced by the pixel unit electrically coupled to the gate line 5, and the load produced by the pixel unit mainly includes a load between the gate line 5 and the transistors, or between the gate line 5 and a source and drain film layer 7 (including a source electrode and a drain electrode) and an active layer film layer 8 (including an active layer) of the transistors in a pixel driving circuit. The load produced by the pixel unit further includes a load formed between the gate line 5 and an anode film layer 9 (including a first electrode) of the light emitting element. By forming different number of compensation capacitors between the gate lines 5 and other film layers in the irregular-shaped display region 3, the load compensation may be performed on the gate lines 5 in the irregular-shaped display region 3, so that the load of the gate lines 5 is substantially consistent with that of the gate lines 5 in the regular-shaped display region 2, and the uniformity of the display brightness of the display panel is enhanced. In the above arrangement, the at least one first capacitor is electrically coupled in parallel, at a side of the pixel units electrically coupled to the same gate line, which are close to the gate line signal input terminal.

It should be noted that, in the embodiment, the two electrode plates of the first capacitor may be manufactured separately, the first electrode plate of the first capacitor may be electrically coupled to the gate line 5, and the second electrode plate of the first capacitor may be electrically coupled to the voltage stabilizing signal terminal. The first electrode plate of the first capacitor and the gate line may be in a same layer and made of a same material. The second electrode plate of the first capacitor may be in the same layer and made of the same material as any one of the source and drain electrodes of the transistor, the anode of the light emitting element and the cathode of the light emitting element. In this case, an additional process is not added to manufacture the capacitor of the display panel, and the process for manufacturing the display panel is simple.

As shown in FIG. 1, the pixel units 1 in the at least one irregular-shaped display region 3 and in the at least one regular-shaped display region 2 are arranged in a plurality of rows, and the number of pixel units in each of the plurality of rows of pixel units in the at least one regular-shaped display region 2 is greater than or equal to the number of pixel units in each of the plurality of rows of pixel units in the at least one irregular-shaped display region 3. That is, the number of pixel units in each of the at least one regular-shaped display region 2 is larger than the number of pixel units in each of the at least one irregular-shaped display region 3. As shown in FIG. 1, the at least one first load compensation circuit 4 and the pixel units electrically coupled to the same gate line 5 are in a same row.

In the present disclosure, as shown in FIG. 5, the at least one irregular-shaped display region 3 may include regions with the pixel units, for example, ridges 31, and a recessed region between the ridges 31. The recessed region may be a hole or a cavity or the like, for placing externally configured devices, such as a camera or the like. FIG. 6 is an enlarged view of one of the ridges 31 in FIG. 5. As shown in FIG. 6, in the irregular-shaped display regions 3, one row of pixel units 1 are electrically coupled to one corresponding gate line 5.

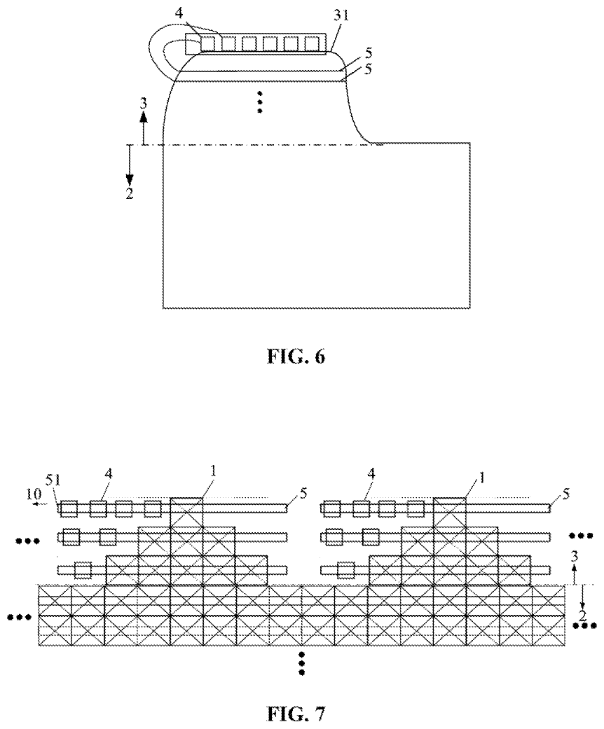

In the embodiment, one irregular-shaped display region 3 is taken as an example. As shown in FIG. 1, the at least one first load compensation circuit 4 includes a plurality of first load compensation circuits 4, and the first load compensation circuits 4 are correspondingly provided close to the gate line signal input terminals 10 in the irregular-shaped display regions 3. Along an extension direction of the gate line, the plurality of first load compensation circuits 4 are electrically coupled to the gate line 5, which is also electrically coupled to the pixel units 1, at a side close to the gate line signal input terminal 10. When the irregular-shaped display region includes two or more irregular-shaped display regions 3, the arrangement of the first load compensation circuits 4 are shown in FIG. 7.

It should be noted that the first load compensation circuits 4 may also be provided along an edge of the irregular-shaped display region 3, for example at an interface between the irregular-shaped display region 3 and the regular-shaped display region 2. In this case, the screen-to-body ratio of the display region in the irregular-shaped display region 3 may be further enhanced, and the visual requirements of people are further met. The first load compensation circuits 4 may also be provided at any position in the irregular-shaped display region 3 where no pixel unit is provided.

It should be further noted that the specific position of the first load compensation circuits 4 is not limited, as long as it is ensured that the first load compensation circuits 4 are at the side closer to the gate line signal input terminal 10 than the pixel units 1 coupled to the same gate line. That is, the signal input through the gate line 5 passes through the first load compensation circuits 4 firstly and then the pixel units 1. In this case, the load compensation on the gate line 5 may be performed by the first load compensation circuits 4 in advance, and it may be ensured that the load of the gate line 5 in the irregular-shaped display region 3 is substantially the same as the load of the gate line 5 in the regular-shaped display region 2.

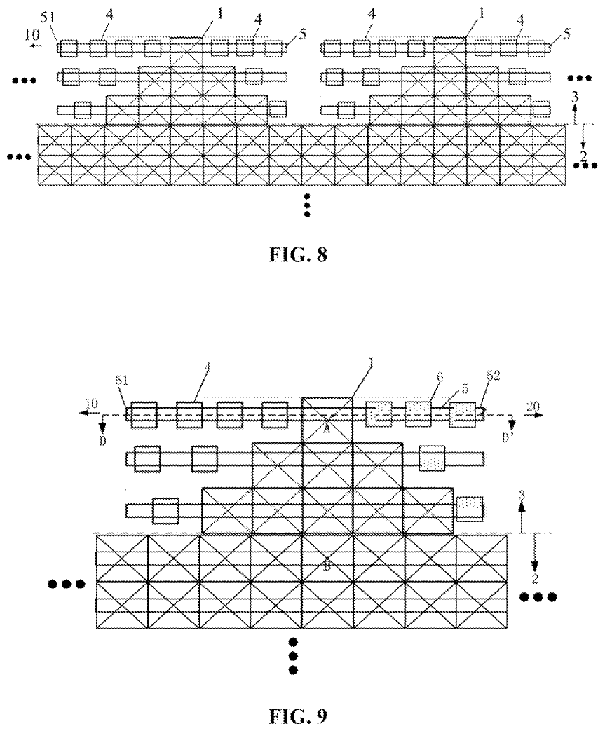

In addition, in the present embodiment, one of the at least one gate line includes a first end 51 and a second end 52 in the at least one irregular-shaped display region 3 and/or in the at least one regular-shaped display region 2. The first end 51 is electrically coupled to one gate line signal input terminal 10, and the second end 52 is electrically coupled to one gate line signal output terminal (as indicated by the arrow 20); or the first end 51 and the second end 52 are electrically coupled to two gate line signal input terminals 10, respectively, and the gate line signal output terminal 20 is electrically coupled to a portion of the gate line other than the first end and the second end. That is, in the irregular-shaped display region 3 and in the regular-shaped display region 2, one row of pixel units may be driven by a single-side driving mode or a double-side driving mode (as shown in FIG. 8).

It should be noted that the light emitting element in the pixel unit 1 may be an organic electroluminescent diode (OLED), a light emitting diode (LED), a micro light emitting diode (Micro LED), or a mini light emitting diode (Mini LED).

Based on the above structure of the electroluminescent display panel, the present embodiment further provides a driving method of the electroluminescent display panel. The driving method includes: sequentially providing a driving signal to the at least one gate line in the regular-shaped display region 2 and in the irregular-shaped display region 3 via a plurality of gate line signal input terminals, respectively. In the regular-shaped display region 2, the driving signal is provided to one row of pixel units via one of the at least one gate line. In the irregular-shaped display region 3, the driving signal is provided to the one row of pixel units after passing through the at least one first load compensation circuit via the one of the at least one gate line. When the electroluminescent display panel is driven, the driving signal input via the gate line firstly passes through the first load compensation circuit and then the pixel unit in the irregular-shaped display region, so that the load compensation may be performed on the gate line in the irregular-shaped display region, and the load on the gate line in the irregular-shaped display region is more consistent with the load of the gate line in the regular-shaped display region.

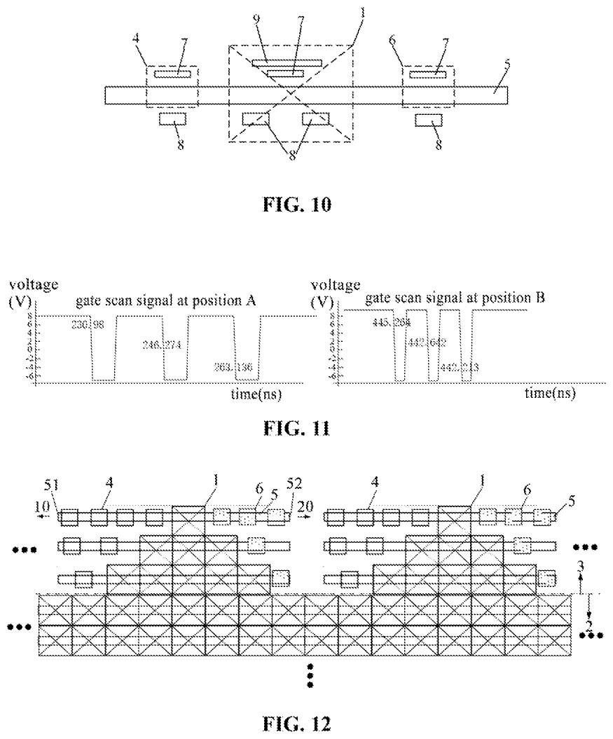

As shown in FIGS. 9 and 10, on the basis of the display panel in the above embodiments, the embodiment further provides an electroluminescent display panel. In the embodiment, at least one second load compensation circuit 6 is further provided in the irregular-shaped display region 3. The at least one second load compensation circuit 6 is electrically coupled to one of the at least one gate line 5. The at least one second load compensation circuit 6 is at a side close to the gate line signal output terminal 20, with respect to the pixel units 1 coupled to the same gate line 5 as the at least one second load compensation circuit 6.

In the present embodiment, the at least one second load compensation circuit 6 is provided on the basis of the at least one first load compensation circuit 4 in the above embodiments. The driving signal through the gate line signal input terminal 10 passes through the at least one first load compensation circuit 4 and the pixel units 1 in sequence via the gate line 5, and then passes through the at least one second load compensation circuit 6. The load compensation is further performed on the gate line 5 by the at least one second load compensation circuit 6 in the irregular-shaped display region 3 on the basis that the load compensation has been performed on the gate line 5 by the at least one first load compensation circuit 4 in the irregular-shaped display region 3 in advance.

By providing the first load compensation circuit 4 and the second load compensation circuit 6, the load compensation may be further performed on the gate line 5 in the irregular-shaped display region 3 on the basis that a load compensation has been performed on the gate line 5 in advance in the irregular-shaped display region 3, so that the load of the gate line 5 in the irregular-shaped display region 3 is more consistent with the load of the gate line 5 in the regular-shaped display region 2, the light emitting brightness of the pixel units 1 in the irregular-shaped display region 3 and in the regular-shaped display region 2 tends to be uniform, thereby improving the brightness uniformity of the display panel and enhancing the display quality.

FIG. 11 is a graph illustrating simulated signal waveforms of the gate lines at the position A in the irregular-shaped display region 3 and at the position B in the regular-shaped display region 2 in FIG. 9 according to an embodiment of the present disclosure for the load compensation on the gate line in the irregular-shaped display region. As shown in the following table 2, for simulated signal waveform parameters of the pixel unit at the position A in the irregular-shaped display region 3, a comparison among the related load compensation solution for the gate line, the load compensation solution for the gate line by adopting only the first load compensation circuit, and the load compensation solution for the gate line by adopting both the first load compensation circuit and the second load compensation circuit (Tf represents a duration for a signal changing from a high level to a low level), is shown.

TABLE 2

| | | | Solution | |
|---|---|---|---|---|
| | | | in the | |
| | | | embodiment | |
| | | | by adopting | |
| | | | only the | Solution |
| | | Solution | first load | in the |
| | | in the | compensation | present |
| | Tf(ns) | related art | circuit | embodiment |
| Irregular-shaped | Tf1 | 228.616 | 232.092 | 230.98 |
| display region | Tf2 | 243.986 | 247.39 | 246.274 |
| (position A) | Tf3 | 260.958 | 264.284 | 263.136 |
| | Average | 244.52 | 247.922 | 246.80 |
| | Tf | | | |
| Regular-shaped | Tf1 | 445.251 | 445.251 | 445.264 |
| display region | Tf2 | 442.667 | 442.667 | 442.642 |
| (position B) | Tf3 | 442.21 | 442.21 | 442.213 |
| | Average | 443.376 | 443.376 | 443.373 |
| | Tf | | | |
| Δtf (%) | | 44.85% | 44.08% | 44.34% |

As may be seen from the table 2, by adopting the load compensation solution for the gate line in the irregular-shaped display region in the embodiment, comparing with the solution in the related art and the solution adopting only the first load compensation circuit, the signal waveform on the gate line at the position A in the irregular-shaped display region has a less change with respect to the signal waveform on the gate line at the position B in the regular-shaped display region, so that a better effect for the load compensation on the gate line in the irregular-shaped display region is achieved.

The second load compensation circuit 6 may include one or more second capacitors. The capacitors are adopted to provide load compensation on the gate lines 5 in the irregular-shaped display region 3, because on one hand, the manufacturing process of a capacitor is simple, and on the other hand, the capacitance value of the capacitor is easily be adjusted in the manufacturing process, the load compensation on the gate lines 5 is more accurate. In the embodiment, the second load compensation circuit 6 including one second capacitor is taken as an example for description, but the present disclosure is not limited thereto. The second load compensation circuit 6 may include a plurality of second capacitors. The capacitance value of a second capacitor may be equal to the capacitance value of the first capacitor.

In the embodiment, the second capacitor in the second load compensation circuit 6 includes a third electrode plate and a fourth electrode plate. A structure, electrical connection relationship and a material of the third electrode plate may be the same as those of the first electrode plate of the first capacitor in the first load compensation circuit 4. A structure, electrical connection relationship and a material of the fourth electrode plate may be the same as those of the second electrode plate of the first capacitor in the first load compensation circuit 4.

An example, in which the number of the first capacitors in the first load compensation circuit 4 and the number of the second capacitors in the second load compensation circuit 6 electrically coupled to each of the gate lines 5 in the irregular-shaped display region 3 are determined according to the load of each of the gate lines 5 and the capacitance value of each of the capacitors, is as follows. Assuming that one pixel unit 1 itself has a load of 25, one first load compensation circuit 4 itself has a load of 20, and one second load compensation circuit 6 itself has a load of 20. In FIG. 9, for example, if the pixel unit 1 at the position A is the 150th pixel unit along the extending direction of the gate line 5, and the pixel unit 1 at the position B is the 150th pixel unit along the extending direction of the gate line 5, the load of the gate line at the position A needs to be compensated by the first load compensation circuit 4 and the second load compensation circuit 6. The number of the missing pixel units 1 on the left side and on the right side of the position A along the extending direction of the gate line 5 may be calculated, respectively. If 30 pixel units 1 are missing on the left side and 20 pixel units 1 are missing on the right side, the number of the first load compensation circuits 4 on the left side is (30×25)/20=37.5, and the number of the second load compensation circuits 6 on the right side is (20×25)/20=25. In practice application, since the capacitors on the left side (i.e., a side close to a gate line signal input terminal) is more important for load compensation, it is preferable to provide the capacitors on the left side of the pixel units 1 at the position A. If a compensation space for the capacitors is limited on the left side, the compensation capacitors may be adjusted to be provided on the right side (i.e., a side close to a gate line signal output terminal) of the pixel units 1 according to practical situations.

Optionally, the capacitance value of the first capacitor is equal to the capacitance value of the second capacitor. The capacitance value of the first and second capacitors is equal to the equivalent capacitance value of one pixel unit.

Optionally, the total number of capacitors in the at least one first load compensation circuit and/or in the at least one second compensation circuit is calculated by: N=(C1−C2)/C(1)

where N denotes the number of capacitors, C1 denotes an equivalent capacitance value of one row of pixel units (including all the pixel units in one row) in the regular-shaped display region, C2 denotes an equivalent capacitance value of one row of pixel units in the irregular-shaped display region, and C denotes a capacitance value of one capacitor.

The total number of capacitors for load compensation in a row of pixel units in the irregular-shaped display region may be calculated through the above formula (1). The number of capacitors on the left side and on the right side may be determined according to the number of missing pixel units respectively on the left side and on the right side of a row of pixel units in the irregular-shaped display region.

In the embodiment, the at least one second load compensation circuit 6 includes a plurality of second load compensation circuits 6. The second load compensation circuits 6 are provided on the gate line signal output terminals 20 respectively in the irregular-shaped display regions 3, and are located at the gate line signal output terminals away from the gate line signal input terminals 10 along an extension direction of the gate line. When the irregular-shaped display region 3 includes two or more irregular-shaped display regions 3, the arrangement of the first load compensation circuits 4 and the second load compensation circuits 6 are shown in FIG. 12.

It should be noted that the at least one irregular-shaped display region is usually provided with a hole or cavity structure for placing externally configured devices such as a camera. As shown in FIGS. 5 and 6, an extending portion (i.e., a portion for electrically coupling to a structure other than the pixel unit) of one of the at least one gate line may extend along an edge of the hole or cavity structure, or may be provided along an edge of the irregular-shaped display region. Therefore, the screen-to-body ratio of an actual display region in the irregular-shaped display region 3 may be further enhanced, and the visual requirement of people may be further met. Alternatively, the extending portion of one of the at least one gate line may be located in a region in the irregular-shaped display region where there is no pixel unit, and the first capacitor and/or the second capacitor may be formed by the extending portion and other film layers of the display panel. As shown in FIGS. 5 and 6, the pixel units may be on the ridges 31, and a region between the ridges 31 is the hole or cavity structure. The first capacitors and/or the second capacitors may be provided on the ridges 31, or at an edge region of the hole or the cavity structure outside the region where the pixel units are located. One end of the gate line 5 is electrically coupled to the pixel units on the ridges 31, and the other end of the gate line 5 extends out of the ridges 31 to form the first capacitor and/or the second capacitor with other film layers of the display panel. As shown in FIG. 5, the arrows schematically show the positions of the capacitors, including a position at a side close to the gate line signal input terminal or a position at a side close to the gate line signal output terminal. For the double-side driving, the arrows between the ridges 31 refer to the capacitors provided along the edge of the hole or cavity structure and close to the gate line signal output terminals, and the other arrows refer to the capacitors close to the gate line signal input terminals. As shown in FIGS. 5 and 6, the at least one first load compensation circuit 4 and/or the at least one second load compensation circuit 6 are provided on a side of the at least one irregular-shaped display region 3 distal to the regular-shaped display region 2, and the at least one first load compensation circuit 4 and/or the at least one second load compensation circuit 6 are provided sequentially and at a uniform interval on a side of the at least one irregular-shaped display region 3 distal to the regular-shaped display region 2. Moreover, optionally, the arrangement sequence of the at least one first load compensation circuit 4 and/or the at least one second load compensation circuit 6 and the sequence of electrical connection to the gate lines in the ridges 31 may be random, as long as it is ensured that the plurality of first capacitors in the at least one first load compensation circuit 4 are arranged sequentially and at a uniform interval at a side close to the gate line signal input terminals, with respect to the gate line electrically coupled to the first capacitors, and/or the second capacitors in the at least one second load compensation circuit 6 are arranged sequentially and at a uniform interval, at a side close to the gate line signal output terminals, with respect to the gate line electrically coupled to the second capacitors.

It should be further noted that the specific position of the second load compensation circuit 6 is not limited, as long as it is ensured that the signal input through the gate line 5 sequentially passes through the first load compensation circuit 4, the pixel units 1, and then the second load compensation circuit 6. In this case, the load compensation on the gate line 5 may be achieved by the first load compensation circuit 4 and the second load compensation circuit 6, and it may be ensured that the load of the gate line 5 in the irregular-shaped display region 3 is substantially consistent with the load of the gate line 5 in the regular-shaped display region 2. As shown in FIGS. 5 and 6, the at least one second load compensation circuit 6 is electrically coupled in parallel, at a side of the pixel units electrically coupled to the same gate line, which are close to the gate line signal output terminal 20.

Optionally, as shown in FIGS. 1, 7 to 9 and 12, the capacitors of the at least one first load compensation circuit 4 are sequentially arranged at a uniform interval on a side of the pixel units 1 electrically coupled to the same gate line, proximal to the gate line signal input terminal 10; and the capacitors of the at least one second load compensation circuit 6 are sequentially arranged at a uniform interval on a side of the pixel units 1 electrically coupled to the same gate line, proximal to the gate line signal output terminal 20, which is beneficial to load balance of the display panel. Moreover, in order to further balance the load, an interval between adjacent first capacitors in two first load compensation circuits adjacent to each other electrically coupled to the same gate line is equal to an interval between any two adjacent first capacitors of the plurality of first capacitors in the at least one first load compensation circuit, and an interval between adjacent second capacitors in two second load compensation circuits adjacent to each other electrically coupled to the same gate line is equal to an interval between any two adjacent second capacitors of the plurality of second capacitors in the at least one second load compensation circuit.

Other structures of the electroluminescent display panel in the embodiment are the same as those of the electroluminescent display panel only provided with the at least one first load compensation circuit, which is not described herein again.

On the basis of the driving method of the electroluminescent display panel only provided with the at least one first load compensation circuit, in the above structure of the electroluminescent display panel on which at least one first load compensation circuit and at least one second load compensation circuit are provided in the irregular-shaped display region, after passing through the row of pixel units, the driving signal reaches the at least one second load compensation circuit via the at least one gate line, thereby achieving further load compensation on the at least one gate line.

When the electroluminescent display panel is driven, in the irregular-shaped display region, a driving signal input via the gate line sequentially passes through the first load compensation circuit, the pixel units and the second load compensation circuit, so that load compensation may be performed on the gate line in the irregular-shaped display region, and the load of the gate line in the irregular-shaped display region is more consistent with the load of the gate line in the regular-shaped display region.

In the electroluminescent display panel of the present disclosure, by providing the irregular-shaped display region, the problem regarding arranging externally configured devices of the display panel is solved under the condition of a small edge space of the display panel. Moreover, by providing the first load compensation circuit close to the gate line signal input terminal relative to the pixel units in the irregular-shaped display region, compared with the related load compensation solution in which the compensation capacitors each are provided close to the gate line signal output terminal, the first load compensation circuit may perform load compensation on the gate lines in the irregular-shaped display region in advance, so that the load of the gate lines in the irregular-shaped display region and the load of the gate lines in the regular-shaped display region tend to be more consistent with each other, and further the light emission brightness of the pixel units in the irregular-shaped display region and in the regular-shaped display region tends to be uniform, thereby improving the uniformity of the display brightness of the display panel and enhancing the display quality of the display panel.

According to another aspect of the present disclosure, a display apparatus is further provided. The display apparatus includes the above electroluminescent display panel and a driving circuit for driving the electroluminescent display panel.

By adopting the electroluminescent display panel in the above embodiment, a full screen display with a high screen-to-body ratio may be achieved, and the uniformity of the display brightness of the display apparatus may be enhanced, thereby improving the display quality of the display apparatus.

The display apparatus in the present disclosure may be any product or component with a display function, such as an OLED panel, an OLED television, a Micro LED panel, a Micro LED television, a Mini LED panel, a Mini LED television, a display, a mobile phone, a navigator and the like.

It should be understood that the above embodiments are merely exemplary embodiments employed to illustrate the principles of the present disclosure, and the present disclosure is not limited thereto. It will be apparent to one of ordinary skill in the art that various changes and modifications may be made therein without departing from the spirit and scope of the disclosure, and these changes and modifications are to be considered within the scope of the disclosure.

1. An electroluminescent display panel, comprising at least one regular-shaped display region and at least one irregular-shaped display region, wherein
the display panel further comprises at least one gate line and at least one pixel unit in each of the at least one regular-shaped display region and the at least one irregular-shaped display region; and at least one gate line signal input terminal electrically coupled to the at least one gate line, respectively, and
the display panel further comprises at least one first load compensation circuit in each of the at least one irregular-shaped display region, the at least one first load compensation circuit is electrically coupled to the at least one gate line, and each of the at least one first load compensation circuit, with respect to a pixel unit of the at least one pixel unit electrically coupled to a same gate line as the first load compensation circuit, is located at a side closer to a corresponding gate line signal input terminal of this gate line.

2. The electroluminescent display panel of claim 1, further comprising at least one second load compensation circuit and at least one gate line signal output terminal electrically coupled to the at least one gate line in each of the at least one irregular-shaped display region,
wherein the at least one second load compensation circuit is electrically coupled to the at least one gate line, and
each of the at least one second load compensation circuit, with respect to a pixel unit of the at least one pixel unit electrically coupled to a same gate line as the second load compensation circuit, is located at a side closer to a corresponding gate line signal output terminal of this gate line.

3. The electroluminescent display panel of claim 2, wherein
each of the at least one first load compensation circuit comprises at least one first capacitor, and
each of the at least one second load compensation circuit comprises at least one second capacitor.

4. The electroluminescent display panel of claim 3, wherein the at least one first capacitor comprises a plurality of first capacitors coupled in parallel, and with respect to the pixel unit of the at least one pixel unit electrically coupled to a same gate line as the plurality of first capacitors, the plurality of first capacitors are located at a side of the pixel unit closer to a corresponding gate line signal input terminal of this gate line.

5. The electroluminescent display panel of claim 4, wherein the at least one second capacitor comprises a plurality of second capacitors coupled in parallel, and with respect to the pixel unit of the at least one pixel unit electrically coupled to a same gate line as the plurality of second capacitors, the plurality of second capacitors are located at a side of the pixel unit closer to a corresponding gate line signal output terminal of this gate line.

6. The electroluminescent display panel of claim 3, further comprising a voltage stabilizing signal terminal, wherein
each of the plurality of first capacitors comprises a first electrode plate and a second electrode plate, the first electrode plate is electrically coupled to the gate line, and the second electrode plate is electrically coupled to the voltage stabilizing signal terminal.

7. The electroluminescent display panel of claim 6, wherein
each of the plurality of second capacitors comprises a third electrode plate and a fourth electrode plate, the third electrode plate is electrically coupled to the gate line, and the fourth electrode plate is electrically coupled to the voltage stabilizing signal terminal.

8. The electroluminescent display panel of claim 7, wherein
the first electrode plate is in a same layer and made of a same material as the gate line.

9. The electroluminescent display panel of claim 8, wherein
the third electrode plate is in a same layer and made of a same material as the gate line.

10. The electroluminescent display panel of claim 3, further comprising a voltage stabilizing signal terminal, wherein
each of the plurality of first capacitors comprises a first electrode plate and a second electrode plate, the gate line also functions as the first electrode plate of the first capacitor, and the second electrode plate is electrically coupled to the voltage stabilizing signal terminal.

11. The electroluminescent display panel of claim 10, wherein
each of the plurality of second capacitors comprises a third electrode plate and a fourth electrode plate, the gate line also functions as the third electrode plate of the second capacitor, and the fourth electrode plate is electrically coupled to the voltage stabilizing signal terminal.

12. The electroluminescent display panel of claim wherein
each of the at least one pixel unit comprises at least one transistor on a base substrate, and each of the at least one transistor comprises a gate electrode, an active layer, a source electrode, and a drain electrode, and
the second electrode plate and the fourth electrode plate are in a same layer and made of a same material as the source electrode and the drain electrode of the transistor.

13. The electroluminescent display panel of claim wherein
each of the at least one pixel unit comprises at least one transistor on a base substrate, and each of the at least one transistor comprises a gate electrode, an active layer, a source electrode, and a drain electrode, and
the electroluminescent display panel further comprises:
a planarization layer on a side of the at least one transistor distal to the base substrate; and
a light emitting element comprising a first electrode, an organic light emitting layer, and a second electrode sequentially arranged on the planarization layer in a direction away from the base substrate, and
the second electrode plate and the fourth electrode plate are in a same layer and made of a same material as the active layer of the transistor, and the first electrode and the second electrode of the light emitting element.

14. The electroluminescent display panel of claim 3, wherein
the at least one pixel unit in each of the at least one irregular-shaped display region and the at least one regular-shaped display region are arranged in a plurality of rows,
the number of pixel units in each of the plurality of rows of pixel units in each of the at least one regular-shaped display region is greater than or equal to the number of pixel units in each of the plurality of rows of pixel units in each of the at least one irregular-shaped display region,
the first load compensation circuit and the pixel unit electrically coupled to a same gate line are in a same row, and
the second load compensation circuit and the pixel unit electrically coupled to a same gate line are in a same row.

15. The electroluminescent display panel of claim 14, wherein
each of the at least one gate line comprises a first end and a second end opposite to each other, and
the first end is electrically coupled to a corresponding gate line signal input terminal of the gate line, and the second end is electrically coupled to a corresponding gate line signal output terminal of the gate line.

16. The electroluminescent display panel of claim 14, wherein
each of the at least one gate line comprises a first end and a second end opposite to each other, and
the first end and the second end are electrically coupled to two corresponding gate line signal input terminals of the gate line, respectively, and a corresponding gate line signal output terminal of the gate line is electrically coupled to a portion of the gate line other than the first end and the second end.

17. The electroluminescent display panel of claim 15, wherein
a capacitance value of the first capacitor is equal to a capacitance value of the second capacitor.

18. The electroluminescent display panel of claim 17, wherein
the capacitance value of the first and second capacitors is equal to an equivalent capacitance value of one of the at least one pixel unit.

19. The electroluminescent display panel of claim 18, wherein
a total number of the first and second capacitors in one row of pixel units in the irregular-shaped display region is calculated by:
N=(C1−C2)/C
where N denotes the total number of the first c capacitors, C1 denotes an equivalent capacitance value of one row of pixel units in the regular-shaped display region, C2 denotes an equivalent capacitance value of one row of pixel units in the irregular-shaped display region, and C denotes a capacitance value of one of the first and second capacitors.

20. A display apparatus, comprising the electroluminescent display panel of claim 1 and a driving circuit for driving the electroluminescent display panel.
